(19) United States
(12) Patent Application Publication
(10) Pub. No.: US 2025/0331976 A1
(43) Pub. Date: Oct. 30, 2025

(54) APPARATUS AND SYSTEM FOR POSITIONING AND RETAINING A SPECIMEN FOR IMAGING AND RELATED METHODS OF IMAGING

(71) Applicant: Phoenix-Micron, Inc., Bend, OR (US)

(72) Inventors: Jonathan Roy Thorn, Bend, OR (US); Tyler Howland, Bend, OR (US); Jonathan Scott Carr, Bend, OR (US); Leslie Mackeen, Toronto (CA)

(73) Assignee: Phoenix-Micron, Inc., Bend, OR (US)

(21) Appl. No.: 19/192,231

(22) Filed: Apr. 28, 2025

Related U.S. Application Data
(60) Provisional application No. 63/640,786, filed on Apr. 30, 2024.

(51) Int. Cl. A61D 3/00; A61D 7/04; A61D 99/00

(52) U.S. Cl. CPC A61D 3/00; A61D 7/04; A61D 99/00

(57) ABSTRACT

The present disclosure provides an apparatus, system, and method for positioning and retaining a specimen for imaging. The apparatus provides a low-profile stand that incorporates multiple functionalities without occluding the imaging path of an imaging device. The apparatus includes a stand having six degrees of freedom of movement in three-dimensional space. The apparatus includes a base member and an upright member extending from the base member. The apparatus includes an adjustable arm including a pivotable stand. The apparatus may include integrated circuitry for heating and sensors to detect various features of a specimen, including blood oxygen, heart rate, blood pressure, respiration rate, or combinations thereof. Additionally, the apparatus includes an integrated fluid delivery system for delivering a fluid to a specimen without occluding the imaging path of an imaging device or restricting movement of the stand.

### CROSS-REFERENCE TO RELATED APPLICATIONS

This application claims priority to and the benefit of U.S. Provisional Patent Application No. 63/640,786, filed Apr. 30, 2024, which is hereby incorporated by reference in its entirety for all intents and purposes.

### TECHNICAL FIELD OF INVENTION

The present disclosure is generally related to an apparatus and system for positioning and retaining a specimen for imaging and related methods. In particular, the present disclosure is related to a multi-functional apparatus configured to position and retain a specimen for imaging that provides omnidirectional movement across several planes of space. Additionally, the apparatus provides integrated functionalities that enable specific conditions for the specimen, for example, heating, monitoring, and gas delivery.

### BACKGROUND OF THE INVENTION

Conventional devices for positioning a specimen for imaging include a stand that positions the subject uniaxially on a flat surface. The stand has a limited range of motion and can only be adjusted along the x or y-direction in three-dimensional space. An imaging device is positioned adjacent to the stand to image one or more sections of the specimen. For eye imaging, the lens of the imaging device may need to directly contact or be close to the eye of the specimen. This requires a low profile stand that enables the camera to be positioned near the eye of the specimen. However, these stands are typically bulky and occlude the imaging path of the imaging device or provide limited options for adjusting the position of the specimen for imaging. This leads to poor quality images of the specimen.

Additionally, in instances when the specimen needs to be immobilized for imaging, an external agent (e.g., gas) may need to be continuously supplied to the specimen and the internal body temperature of the specimen may need to be maintained to prevent loss of life during imaging. In this regard, external equipment may be needed to supply the external agent and maintain the body temperature of the specimen. For example, a fluid line may need to be attached to the specimen to supply an external agent to the specimen, and an external heat source (e.g., a heating hood) may be needed to maintain the body temperature of the specimen. However, these external devices further occlude the imaging path, increase the overall profile of the stand providing for limited viewing angles, and limit the range of motion of the stand.

Therefore, devices and systems are needed for efficient ways of manipulating and positioning a specimen for imaging and provides a low-profile that allows imaging from several angles, while incorporating multiple functionalities.

### SUMMARY OF THE INVENTION

The present disclosure relates to an apparatus, system, and method for positioning a specimen for imaging. In particular, the present disclosure provides an apparatus, system, and method for imaging a specimen on a low-profile stand that incorporates multiple functionalities without occluding the imaging path of an imaging device. Beneficially, the apparatus provides multiple degrees of freedom for positioning a specimen for imaging that provides a clear imaging path and multiple viewing angles, and decreases the overall profile of the stand, while incorporating other functionalities, such as heating and monitoring blood oxygen, heart rate, blood pressure, respiration rate, or combinations thereof. Additionally, the apparatus provides an integrated cable and hose management system that provides multiple functionalities to the apparatus without occluding the imaging path of an imaging device or restricting movement of the stand.

Embodiments of the present invention provide an apparatus for positioning a specimen for imaging, the apparatus comprising: a base member comprising a first end and a second end; an upright member disposed at or adjacent to the second end of the base member, wherein the upright member comprises a rotatable support; an adjustable arm extending from the upright member, wherein the adjustable arm comprises: a mounting arm coupled to the rotatable support on the upright member; a pivot attached to a distal end of the mounting arm; and a stand attached to the pivot and disposed over the mounting arm; a first adjustment means disposed on the upright member and coupled to the adjustable arm via the rotatable support, wherein the first adjustment means is configured to adjust the yaw of the adjustable arm; a second adjustment means coupled to the upright member, wherein the second adjustment means is configured to move the upright member in a y-direction; wherein the stand can be rotated away or toward to the upright member via the pivot.

Embodiments of the present invention provide a system for imaging a specimen, the system comprising: an apparatus for positioning a specimen for imaging, the apparatus comprising: a base member comprising a first end and a second end; an upright member disposed at or adjacent to the second end of the base member, wherein the upright member comprises a rotatable support; an adjustable arm extending from the upright member, wherein the adjustable arm comprises: a mounting arm coupled to the rotatable support on the upright member; a pivot attached to a distal end of the mounting arm, wherein the pivot comprises an inlet; and a stand attached to the pivot and disposed over the mounting arm; a first adjustment means disposed on the upright member and coupled to the adjustable arm via the rotatable support, wherein the first adjustment means is configured to adjust the yaw of the adjustable arm; a second adjustment means coupled to the upright member, wherein the second adjustment means is configured to move the upright member in a y-direction; wherein the stand can be rotated away or toward to the upright member via the pivot; a gas delivery system comprising one or more fluid lines coupled to the inlet of the pivot; a sealing device removably attached to a distal end of the pivot; and an imaging device.

Embodiments of the present invention provide a method of positioning and imaging a specimen, the method comprising: providing an apparatus for positioning a specimen for imaging, the apparatus comprising: a base member comprising a first end and a second end; an upright member disposed at or adjacent to the second end of the base member, wherein the upright member comprises a rotatable support; an adjustable arm extending from the upright member, wherein the adjustable arm comprises: a mounting arm coupled to the rotatable support on the upright member; a pivot attached to a distal end of the mounting arm, wherein the pivot comprises an inlet; and a stand attached to the pivot and disposed over the mounting arm; a first adjustment means disposed on the upright member and coupled to the adjustable arm via the rotatable support, wherein the first adjustment means is configured to adjust the yaw of the adjustable arm; a second adjustment means coupled to the upright member, wherein the second adjustment means is configured to move the upright member in a y-direction; wherein the stand can be rotated away or toward to the upright member via the pivot; positioning a specimen on the stand; adjusting the position of the specimen on the stand by exerting a force on one or more of the first adjustment means, the second adjustment means, or the pivot; and imaging the specimen.

### BRIEF DESCRIPTION OF FIGURES

FIG. 1 illustrates a side view of an apparatus for positioning a specimen for imaging according to some embodiments.

FIG. 2A illustrates an exploded perspective view of an apparatus for positioning a specimen for imaging according to some embodiments.

FIG. 2B illustrates another exploded perspective view of an apparatus for positioning a specimen for imaging according to some embodiments.

FIGS. 3A and 3B illustrate a perspective view of the stand of the apparatus for positioning a specimen for imaging according to some embodiments.

FIGS. 4A-4C illustrate a gas delivery system of the apparatus for positioning a specimen for imaging according to some embodiments.

FIGS. 5A-5D illustrate a cable management system of the apparatus for managing cables and tubing according to some embodiments.

FIGS. 6A-6C illustrate a sealing device sealing device removably attached to the apparatus for gas delivery to a specimen.

FIGS. 7A-7D illustrate a sealing device including elongated flexible shafts configured to retain or hold external obstacles (e.g., eyelashes or whiskers) away from the eye of a specimen for imaging.

FIGS. 8A-8C illustrate an apparatus including electrical ports and integrated wire routing for electronic components.

FIGS. 9A and 9B illustrate an apparatus including integrated sensor ports and monitoring devices on the apparatus for collecting sensor readings from the specimen.

FIG. 10 illustrates an apparatus including grounding components for high-gain sensors to filter signal or noise from readings.

FIG. 11 illustrates an apparatus including an integrated scale for collecting weight data from the specimen.

FIGS. 12A and 12B illustrate specimen restraining devices to restrain a specimen to a stand of the apparatus while the specimen is awake or sedated.

FIG. 13 provides a method of positioning and imaging a specimen according to some embodiments.

FIGS. 14A and 14B show an apparatus including an integrated circuit board according to some embodiments.

### DETAILED DESCRIPTION OF SPECIFIC EMBODIMENTS

The present disclosure describes a number of embodiments related to an apparatus, system, and method for positioning and retaining a specimen for imaging. In some embodiments, an apparatus is provided for receiving and positioning a specimen on a stand. The apparatus has at least six degrees of freedom of movement in three-dimensional space. For example, the stand is free to move positions in a forward/backward direction, up/down direction, and left/right direction in three perpendicular axes, combined with changes in orientation through rotation about three perpendicular axes, often termed yaw (normal axis), pitch (transverse axis), and roll (longitudinal axis). Beneficially, the apparatus is configured to position and retain a specimen for imaging that provides omnidirectional movement across several planes of view, thereby providing various imaging paths. Additionally, the apparatus provides integrated functionalities that enable specific conditions for the specimen, for example, heating the specimen to a body temperature, monitoring vitals (e.g., heart rate, pulse, etc.), and gas delivery.

The apparatus includes a base member and an upright member. The base member is configured to contact or rest on a surface (e.g., a table surface). The upright member extends from the base member. In some embodiments, the upright member is perpendicular to the base member. The apparatus provides a low-profile stand that incorporates multiple functionalities without occluding the imaging path of an imaging device. For example, the stand may include a heating element that can maintain the body temperature of a specimen. The apparatus may include integrated circuitry for sensors to detect various features of the specimen, including blood oxygen, heart rate, blood pressure, respiration rate, or combinations thereof. Additionally, the apparatus provides an integrated cable and hose management system for gas delivery that provides multiple functionalities to the apparatus without occluding the imaging path of an imaging device or restricting movement of the stand.

The apparatus includes an adjustable arm mounted to the upright member. The adjustable arm includes a mounting arm having a first end and a second end. The first end of the mounting arm is attached to the upright member. In some embodiments, the first end of the mounting arm is attached to a rotatable support disposed on the upright member. The rotatable support disposed on the upright member can be coupled to a first adjustment means. For example, the first adjustment means can be a knob, a button, a switch, a handle, or other means for exerting a force on the rotatable support. The first adjustment means is configured to adjust the tilt (i.e., yaw) of the adjustable arm via the rotatable support. For example, the rotatable support may include a first set of grooves that mate with a second set of grooves disposed on the mounting arm such that when the first adjustment means is actuated, the adjustable arm is tilted in a direction.

The adjustable arm includes a pivot attached to the mounting arm. In some embodiments, the pivot is disposed at a distal end of the mounting arm. The pivot connects the mounting arm to a stand or platform. For example, the pivot is coupled to both the mounting arm and the stand. The stand may be positioned over the mounting arm. The pivot is configured to allow the stand to move about a 360° axis. In some embodiments, the pivot includes a rotatable member that is housed in the mounting arm and coupled to the stand. In this way, that stand can rotate freely via the pivot. The stand may include a base and two opposing sidewalls. In some embodiments, the sidewalls are disposed at an obtuse angle relative to the base. The base may include a groove for receiving waste from a specimen. In some embodiments, the base includes an absorbent pad (e.g., within the groove or disposed on the base). The absorbent pad can be glued or otherwise attached to the base. In some embodiments, the stand can include an integrated heating device and heating sensors. For example, the stand may comprise a thermally conductive material such as a metal (e.g., aluminum) to distribute heat evenly to the animal. The heating element can be a removable insert that is received by the stand. The heating element may include a temperature sensor to maintain and facilitate precise temperature control. In some embodiments, an external heating element can be placed on the stand for heating.

In some embodiments, the apparatus includes a fluid delivery system. The fluid delivery system may be integrated into the apparatus for fluid (e.g., gas or liquid) delivery to the specimen. In some embodiments, the gas delivery system is integrated into the pivot of the animal stand to provide a low-profile fluid delivery system that does not occlude the imaging path. For example, the pivot can include an inlet to receive a fluid line to supply fluid to a specimen and an outlet to remove fluid from the specimen. The inlet and outlet are provided to both supply and dispose of fluid thus preventing gas from escaping into the environment. The fluid delivery system provides a seamless way to route gas or other fluids without any risk of kinking or damaging delivery lines, while also improving hose management.

In some embodiments, the apparatus includes a sealing device. The sealing device can be removably attached to an end of the pivot. The sealing device is configured to provide a seal around the nose and mouth of a specimen to prevent gas from leaking into the environment while helping ensure a known concentration of fluid (e.g., anesthesia gas) is being delivered to the specimen. The sealing device may include an interior volume to receive the mouth and nose of the specimen. The entry to the sealing device may comprise a flexible material to fit snugly to the face of the specimen (e.g., a flexible material profiled to fit the face of a specimen). For example, the receiving end of the sealing device (e.g., a portion of the front face) may comprise a flexible material that conforms to the specimen. In some embodiments, the front face of the sealing device may comprise a shape memory material such as foam. The sealing device seals and directs the fluid delivery to the nose and mouth of the specimen while creating minimal additional bulk.

The sealing device may include at least two shafts extending from the front face of the sealing device. At least two shafts extending from the front face of the sealing device may be positioned adjacent to the receiving end of the sealing device for receiving a portion of the face of a specimen. The shafts comprise a soft and flexible material (e.g., a polymer-based material or foam). The shafts are configured to wipe along the face of the specimen as the sealing device is attached to the pivot. In this way, any external appendages (e.g., whiskers or eyelashes) can be pushed and restrained away from the face of the specimen (e.g., the eyes of the specimen). As such, external features of the specimen do not block the imaging path of an imaging device. For example, when imaging the eyes of a specimen, the shafts can pin down whiskers away from the eyes of the specimen.

In some embodiments, the apparatus includes integrated electronic circuitry that leads to the stand. The stand may include one or more sensor ports that are in communication with the electronic circuitry. In some embodiments, a connector may be coupled to at least one of the sensor ports. The connector is configured to provide one or more connection ports to attach an external device. For example, one or more sensor ports may include connect ports for a blood oxygen monitor, a heart rate monitor, a blood pressure monitor, a respiration rate monitor, a blood oxygen monitor, or combinations thereof. In some embodiments, the connector is a magnetic connector.

The apparatus includes one or more restraints configured to retain a specimen on the stand. For example, the restraints may be configured to apply pressure between the specimen and the stand. In some embodiments, the restraints can be Velcro straps, a rubber strap, or a ratcheting mechanism. For example, the rubber strap may include a plurality of apertures and a pin. The pin can be inserted into one of the plurality of apertures to provide a snug fit of the specimen to the stand. In some embodiments, Velcro straps may be an external element (i.e., not coupled to the apparatus). In this way, the Velcro straps can be applied to the desired region of the stand to restrain the specimen. The Velcro straps may extend around the mounting arm and the stand to provide the desired tension to the specimen.

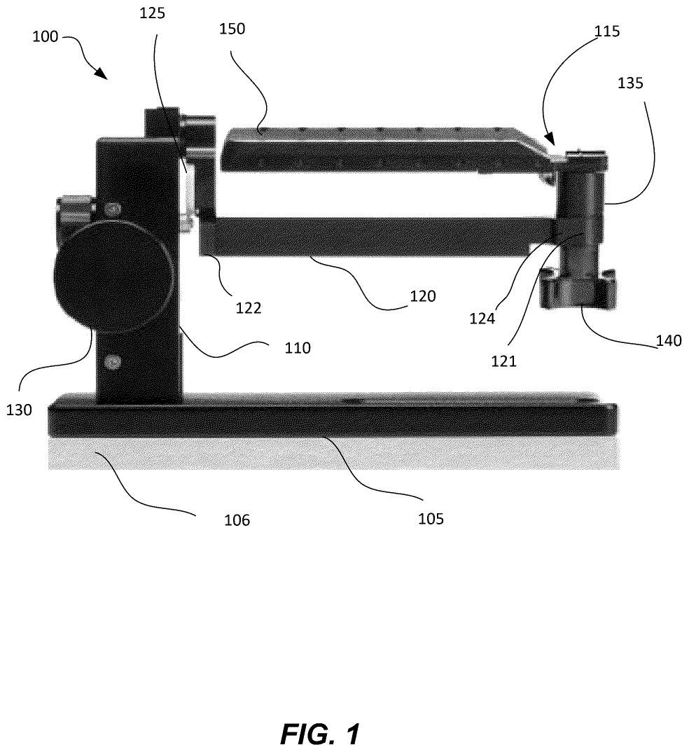

FIG. 1 illustrates a front perspective view of an apparatus for positioning a specimen for imaging according to some embodiments. The apparatus 100 provides a low-profile stand that incorporates multiple functionalities without occluding the imaging path of an imaging device. For example, the apparatus 100 may include a heating element that can maintain the body temperature of a specimen. The apparatus 100 may also include integrated circuitry for sensors to detect various features of the specimen, including blood oxygen, heart rate, blood pressure, respiration rate, or combinations thereof.

The apparatus 100 includes a base member 105 and an upright member 110. The base member 105 is configured to contact or rest on a surface (e.g., a table surface). In some embodiments, the base member 105 may include a non-slip material 106 (e.g., rubber) disposed on a bottom surface. The non-slip material may prevent the apparatus 100 from moving during imaging or rotation of the stand. The upright member 110 extends from the base member 105. In some embodiments, the upright member 110 is perpendicular to the base member 105. The upright member 110 can be fixed to the base member 105.

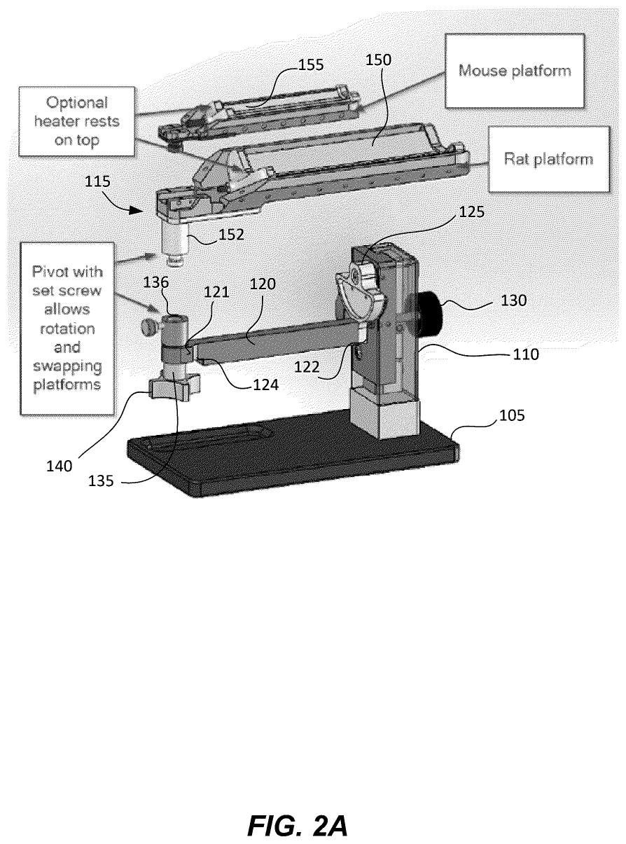

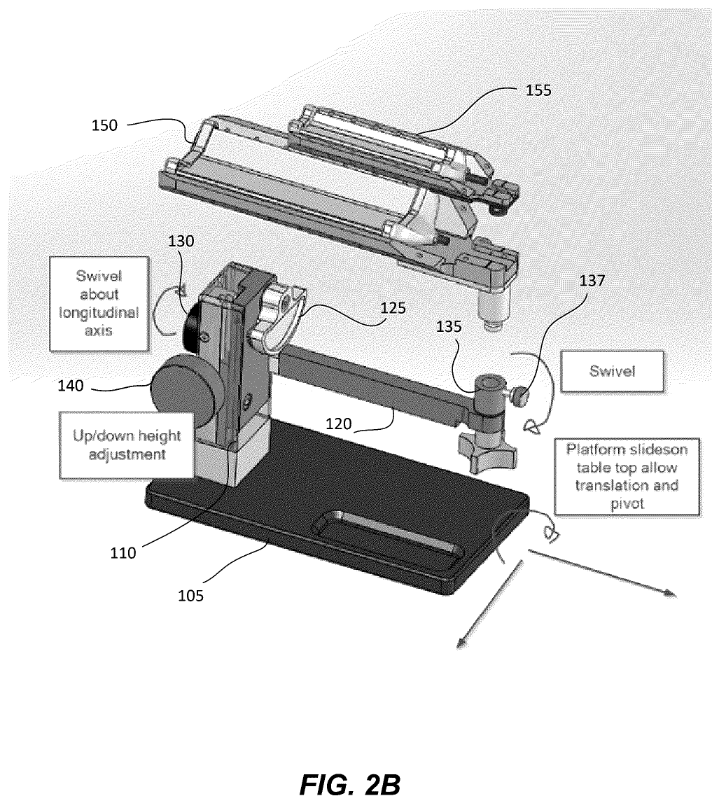

The apparatus 100 includes an adjustable arm 115 attached to the upright member 110. The adjustable arm includes a mounting arm 120 having a first end 122 and a second end 124. The first end 122 of the mounting arm 120 is attached to the upright member 110 via a rotatable support 125. FIG. 2A shows the first end 122 of the mounting arm 120 is attached to a rotatable support 125 disposed on the upright member 110. The rotatable support 125 disposed on the upright member 110 can be coupled to a first adjustment means 130. For example, the first adjustment means 130 can be a knob, a button, a switch, a handle, or other means for exerting a force on the rotatable support 125. The first adjustment means 130 is configured to adjust the tilt (e.g., yaw) of the adjustable arm 115 via the rotatable support 125. For example, the rotatable support 125 may include a first set of grooves that mate with a second set of grooves disposed on the mounting arm 120 such that when the first adjustment means 130 is actuated, the adjustable arm 115 is tilted in a direction.

The second end 124 of the mounting arm 120 is coupled to a pivot 135. In some embodiments, the second end 124 of the mounting arm 120 includes a receptacle 121 for receiving the pivot 135 therein. For example, the receptacle 121 includes an aperture for receiving the pivot 135. The pivot 135 includes a second adjustment means 140. The pivot 135 is configured to move about a 360-degree axis by applying a force to the second adjustment means 140. For example, the second adjustment means 140 can be rotated to move the pivot 135. The pivot 135 is coupled to a stand 150. The rotation of the second adjustment means 140 on the pivot 135 moves the stand 150 in a desired direction around the pivot 135. In this way, the adjustable arm 115 can control the rotation and angle of the stand 150 to provide freedom of movement in three-dimensional space.

FIGS. 2A and 2B illustrate exploded views of the apparatus for positioning a specimen for imaging according to some embodiments. The apparatus 100 includes a pivot 135 attached to the mounting arm 120. The pivot 135 is disposed at a distal end of the mounting arm 120. The pivot 135 includes a receiving member 136. The receiving member 136 can be disposed above the mounting arm 120. The second adjustment means 140 is coupled to or integral with the receiving member 136. In some embodiments, the second adjustment means 140 is disposed below the receptacle 121 of the mounting arm 120 and the receiving member 136 is disposed above the receptacle 121 of the mounting arm 120. The receiving member 136 can include a screw. The screw can secure a portion of the adjustable arm 115 in the receiving member 136. For example, the adjustable arm 115 may include a locking pin 152 that is received within the receiving member 136. The screw can secure the locking pin 152 within the receiving member 136 of the pivot 135. In this embodiment, the pivot 135 couples the mounting arm 120 to the adjustable arm 115. The pivot 135 is configured to allow the adjustable arm 115 to move about a 360° axis.

As shown in FIGS. 2A and 2B, the adjustable arm 115 including the stand 150 can be removably attached to the pivot 135 of the mounting arm 120. The pivot 135 is configured to removably couple the stand 150 to the mounting arm 120. The stand 150 includes a platform 155. The platform extends from a first end 122 to a second end 124 of the mounting arm 120. In some embodiments, the platform 155 comprises a conductive material. The conductive material can be a metal product. For example, the conductive material can be aluminum, an alloy, a nickel-based alloy, steel, tin, or any other suitable metal that can conduct heat.

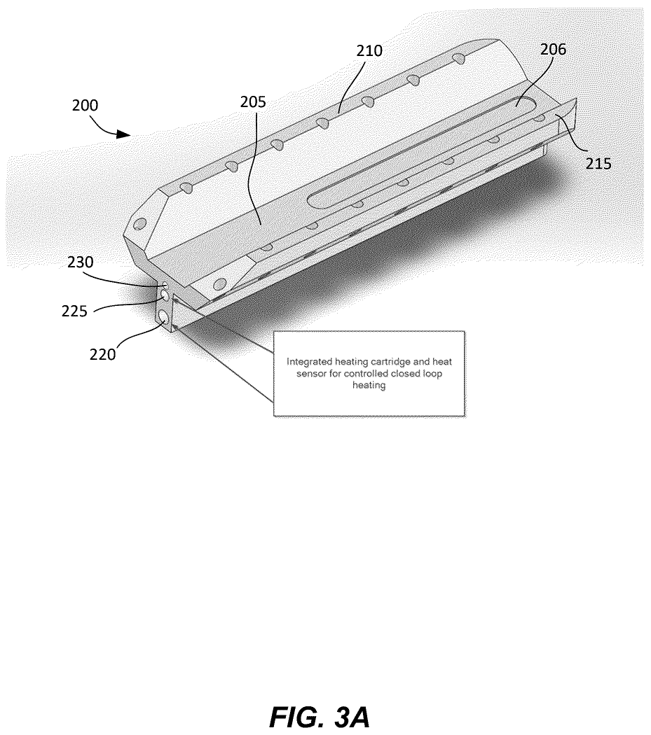

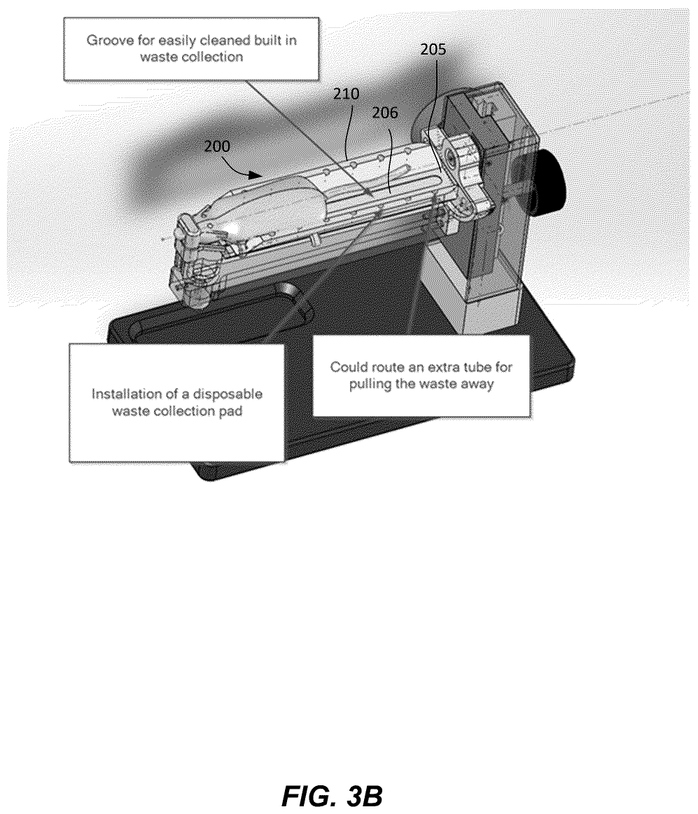

FIGS. 3A and 3B show the stand 200 of the apparatus for receiving a specimen thereon. The stand 200 includes a base member 205. The base member 205 may be substantially flat to provide a surface for receiving the specimen thereon. In some embodiments, the base member 205 may be substantially planar. In some embodiments, the base member 205 comprises a width of at least 1 cm. For example, the base member 205 comprises a width of 2 cm, 4 cm, 6 cm, 8 cm, 10 cm, 12 cm, 14 cm, 16 cm, 18 cm, or 20 cm.

The stand 200 may include a base member 205 and two opposing sidewalls. The first sidewall 210 and the second sidewall 215 may be disposed on opposing sides of the base 205. The first sidewall 210 and the second sidewall 215 form an angle with respect to the base surface. In some embodiments, the first sidewall 210 and the second sidewall 215 form an angle with the base from 90° to 180°. In some embodiments, the first sidewall 210 and the second sidewall 215 form an obtuse angle (e.g., more than) 90°. The overall shape of the base member 205, the first sidewall 210, and the second sidewall 215 can be U-shaped, V-shaped, semi-circular, circular, oval-shaped, square-shaped, or rectangular. The first sidewall 210 and the second sidewall 215 are configured to hold the specimen within the walls and on the base 205 of the stand 200.

The base 205 may include a groove 206 for receiving waste from a specimen. In some embodiments, the base 205 and/or groove 206 include an absorbent pad (e.g., within the groove or disposed on the base). The absorbent pad can be glued or otherwise attached to the base 205 and/or groove 206. The absorbent pad can be removable from the base 205. The base 205 may include an interior volume for receiving a heat element 220. For example, the base 205 can receive a heating element 220 cartridge that be received within the base. The base 205 may include a heat sensor port 225 adjacent to the heating element 220. The heat sensor port 225 is configured to receive a heat sensor to provide real-time temperature data to provide controlled closed loop heating. In this way, the temperature of the specimen can be maintained at a specific level.

In some embodiments, the stand 200 can include an integrated heating element and heating sensors. For example, the stand 200 may comprise a thermally conductive material such as a metal (e.g., aluminum) to distribute heat evenly to the specimen. The heating element 225 can be a removable insert that is received within the stand. The heating element 225 may include a temperature sensor to maintain and facilitate precise temperature control. In some embodiments, an external heating element can be placed on the stand for heating. In some embodiments, the stand 200 itself is the heating apparatus that increases in temperature from a heating element.

The stand 200 can maintain normal body temperature of a specimen during a sequence of observations or imaging. For example, for comfort and safety, and to prevent certain variations in measurement associated with decreased body temperature, the stand can provide heating such that a specimen can be kept at normal body temperature during a sequence of observations or imaging. When anesthetized, a specimen can go into hypothermia. The integrated heating and heat control for the stand can maintain body temperature and prevent hypothermia. In some embodiments, the heating element is removable and inserts into the stand via a port. The stand can include a temperature sensor to maintain a precise temperature that would avoid burning or harming the specimen. In some embodiments, the stand is thermally conductive, distributing heat evenly to the specimen. The heated stand can be combined with a body temperature sensor to modulate the duration and temperature of the stand to optimize body temperature for specimens of varying sizes and species while not exceeding a temperature that would be harmful. In some embodiments, the stand can be fitted with attachment points to add a blanket cover to reduce heat loss.

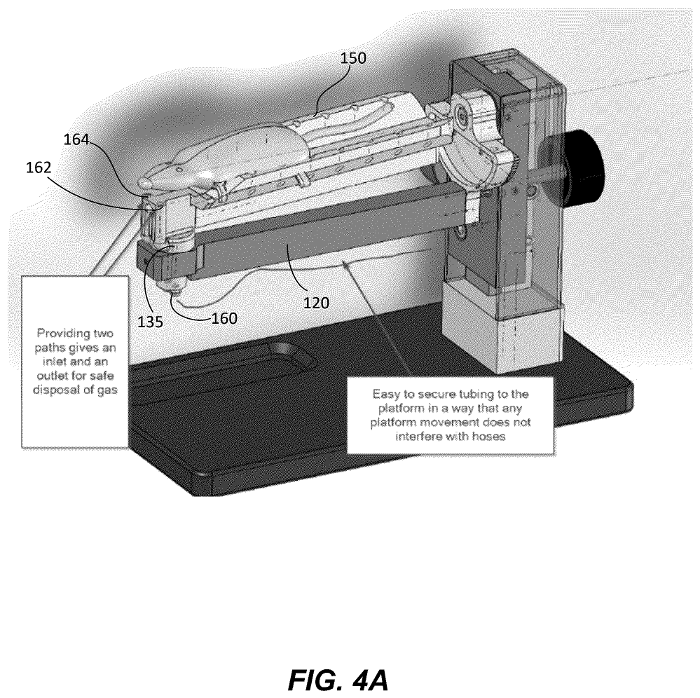

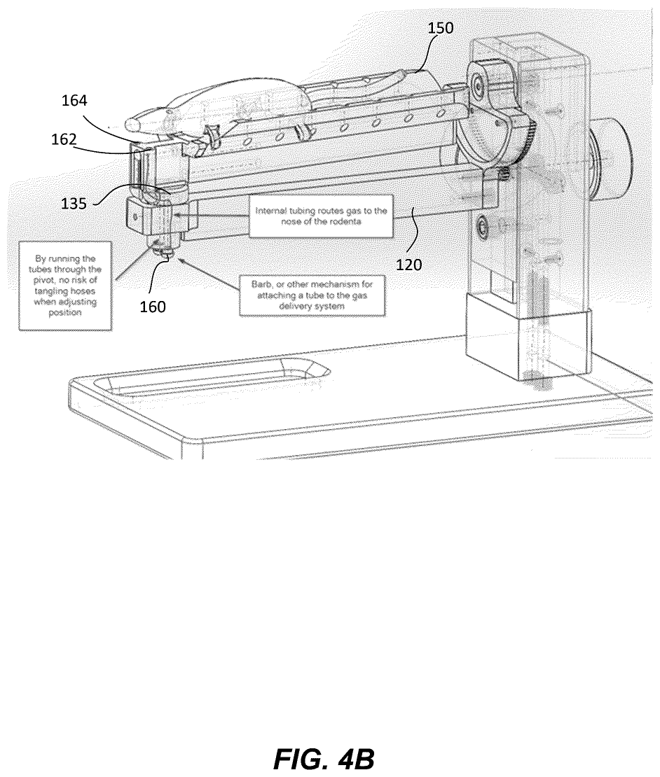

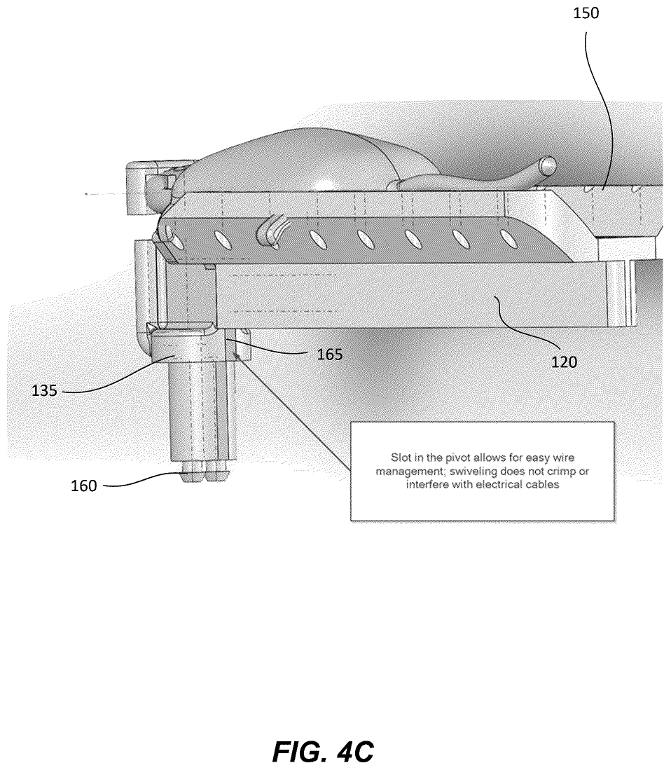

FIGS. 4A-4C show a specimen positioned on the stand of the apparatus for fluid delivery according to some embodiments. The pivot 135 can include an interior volume for receiving one or more fluid lines. For example, the housing of the pivot 135 can receive fluid delivery lines that deliver a fluid to the specimen disposed on the stand 150. The fluid delivery line can be routed through or under the mounting arm 120 to the pivot 135. For example, the fluid delivery lines can be attached to the mounting arm 120. In some embodiments, the fluid delivery lines can be integrated within the mounting arm 120. In some embodiments, the fluid delivery lines can be housed in the region below the mounting arm 120.

In some embodiments, the pivot 135 includes one or more ports 160 for receiving fluid delivery lines. The fluid delivery lines can be attached to the one or more ports 160 to deliver a fluid. The pivot 135 can include one or more internal channels for delivering fluid to a specimen via outlet port 162. The outlet port 162 may include an aperture at a distal end of the channel or pivot 135 to provide fluid to a specimen. For example, FIG. 4B shows fluid delivery lines that can be routed through the pivot 135 to the channels for fluid delivery to a specimen on a stand 150 via outlet port 162. Any excess fluid or gas exhaled by the specimen can be received in intake port 164. This prevents excess fluid or gas from escaping to a surrounding environment. The pivot 135 provides a simpler profile for receiving fluid delivery lines that prevents tangling or impinging fluid delivery lines when the stand 150 is rotated or moved.

FIG. 4C shows a slot of the pivot 135 that can provide access for receiving other cables (e.g., electrical wires). In some embodiments, the slot 165 is an aperture between two ports 160 that receive fluid delivery lines. The slot is configured to receive wiring or electrical cables therein. The slot prevents the wiring or electrical cables from crimping or damage and allows for efficient cable management. The slot 165 allows for simple wire management and prevents crimping or interference with stand movement. The pivot 135 is able to rotate about a 360° axis on the mounting arm 120 without damaging wires or relocating the wires. In some embodiments, the slot is disposed along a portion of the pivot. For example, the slot can extend at least 50% of the length of the pivot.

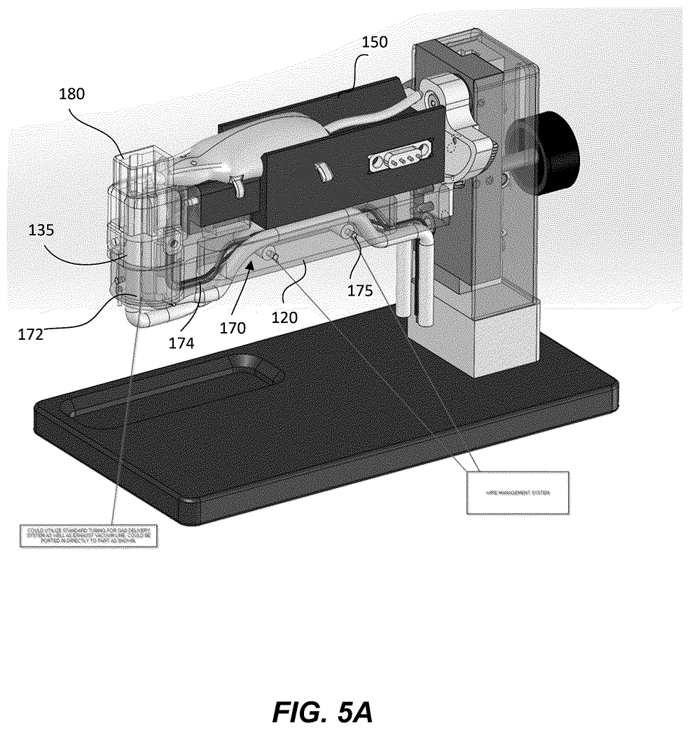

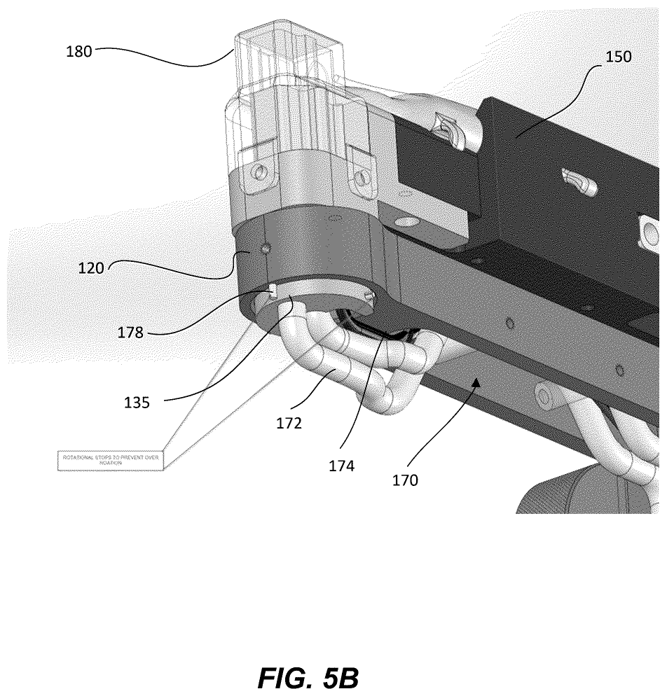

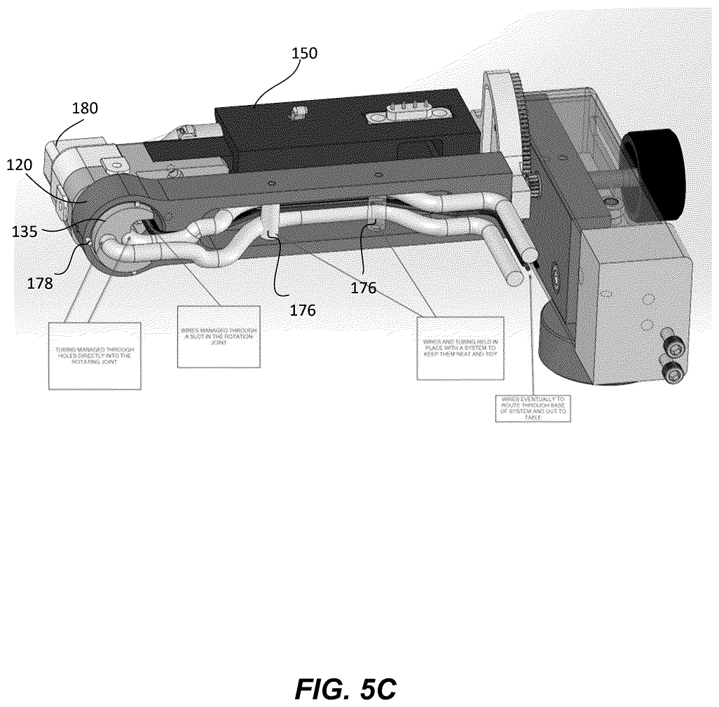

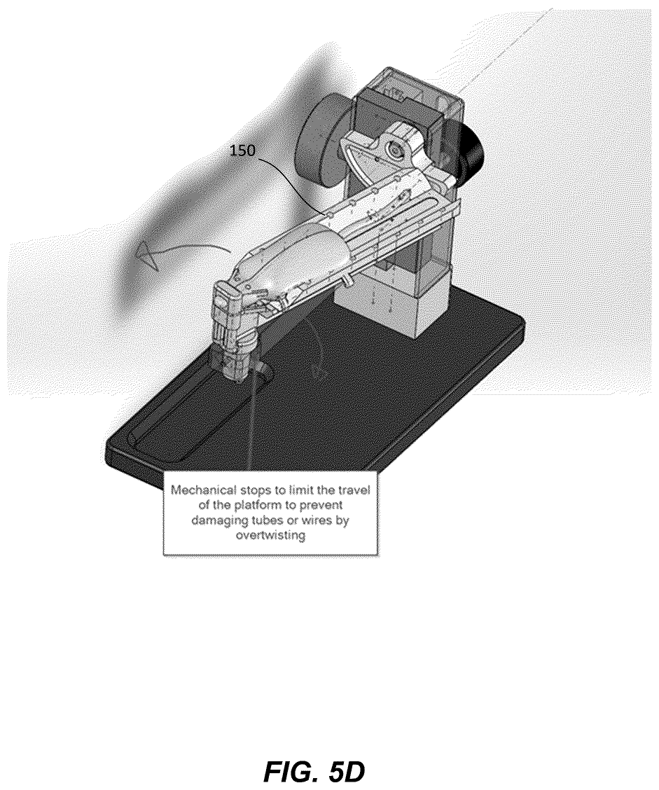

FIGS. 5A-5C show an internal view of an apparatus including a cable management system. The cable management system 170 is configured to route any cables, wires, and/or tubing to regions of the stand 150. For example, the cable management system 170 can provide routing of fluid delivery lines 172 and/or electrical wires 174 through the apparatus 100 to the pivot 135 and/or the stand 150. The cable management system 170 may be integrated into the apparatus 100 for fluid (e.g., gas or liquid) delivery to the specimen. In some embodiments, the cable management system 170 is integrated into the mounting arm 120 of the apparatus. The mounting arm 120 may include an interior volume for the cable management system 170 that receives fluid delivery lines 172 and/or electrical wires 174. In some embodiments, the cable management system 170 may comprise a housing that is attached to or separate from the mounting arm 120. For example, the cable management system 170 can be disposed below the mounting arm 120.

In some embodiments, the cable management system 170 includes fluid delivery lines 172. The fluid delivery lines 172 can be tubing configured to receive a fluid (e.g., gas). The fluid delivery lines 172 may comprise tubing for delivery to a specimen via the pivot 135. In some embodiments, the fluid delivery lines 172 comprise a first tube for delivering a gas to a distal end of the pivot 135 and a second tube for exhausting any gas. The distal end of the pivot 135 may be adjacent to the stand 150. The first tube may deliver a gas from an external source to the stand 150. In this way, the first tube of the fluid delivery lines 172 can deliver a gas to a specimen disposed on the stand 150. The second tube can provide a vacuum at the distal end of the pivot 135 to exhaust any gas. In some embodiments, a sealing device 180 is disposed at the distal of the pivot 135. The sealing device 180 is configured to retain fluid from the gas delivery system. As shown in FIG. 5A, the sealing device can be disposed over the nose and mouth of a specimen for effective gas delivery. The sealing device 180 can be removably attached to one end of the pivot 135.

FIGS. 5B and 5C show an underside view of the cable management system 170, with a portion of the mounting arm 120 including the cable management system 170. The cable management system 170 can provide routing of fluid delivery lines 172 and/or electrical wires 174 through the apparatus 100 to the pivot 135 and/or the stand 150. The fluid delivery lines 172 may be routed through the mounting arm 120 to the pivot 135. The portion of the fluid delivery lines 172 disposed in the housing of mounting arm 120 can be enclosed to prevent access to the lines. The fluid delivery lines 172 in the housing of the mounting arm can be retained or held in place in the mounting arm 120 via supports 176.

The pivot 135 may include one or more rotational stops 178. The rotational stops 178 can be pegs disposed on an outer circumference of the pivot 135. The rotational stops 178 can limit the rotation of the pivot such that it does not pinch or twist the fluid delivery lines 172 and/or electrical wires 174. As shown in FIG. 5D, the rotational stops 178 limit the movement of the stand 150 to prevent damaging or twisting of the fluid delivery lines 172 and/or electrical wires 174. The fluid delivery lines 172 and/or electrical wires 174 can be routed through the cable management system 170 to pivot 135. In some embodiments, the cable management system 170 routes the fluid delivery lines 172 and/or electrical wires 174 through the entire apparatus 100. The cable management system 170 provides a low-profile system to route tubing and wiring that does not occlude the imaging path of the specimen. The cable management system 170 provides a seamless way to route gas or other fluids without any risk of kinking or damaging delivery lines, while also improving hose management.

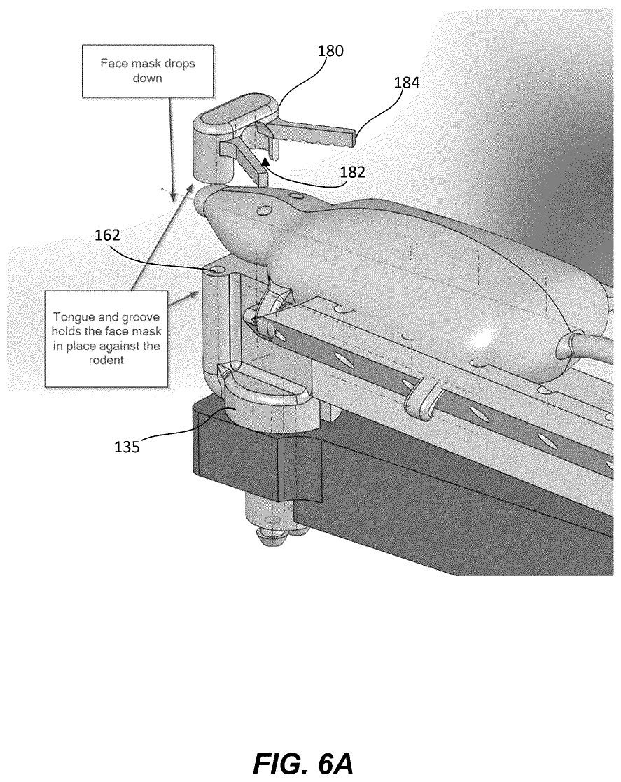

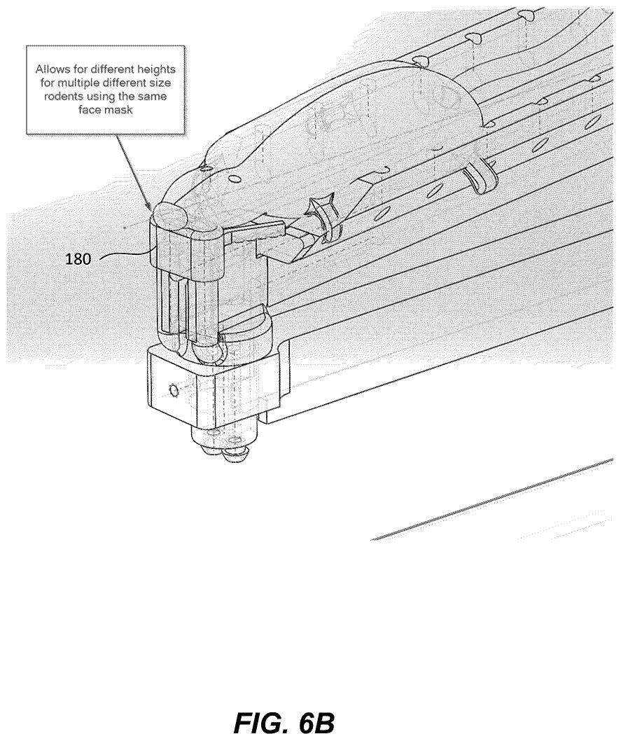

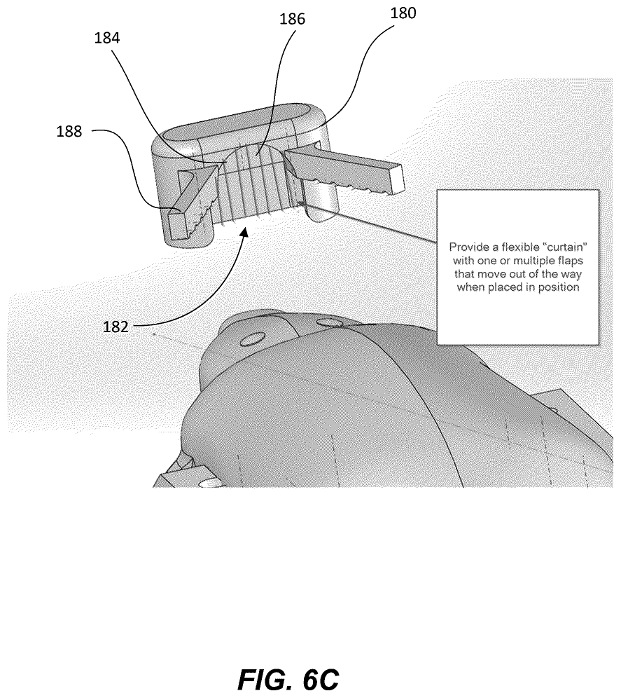

FIGS. 6A-6C show a sealing device 180 configured to receive a fluid. In some embodiments, the fluid is a gas. The fluid can be delivered to the sealing device 180 via the fluid delivery lines routed through the apparatus via the cable management system. As shown in FIG. 6A, the sealing device 180 can be disposed over the nose and mouth of a specimen for effective gas delivery. In some embodiments, the sealing device 180 can be removably attached to one end of the pivot 135. For example, the sealing device 180 can include fasteners that are configured to attach to the pivot 135. In some embodiments, the sealing device 180 can be press-fit or magnetically attached to the pivot 135 of the apparatus. In some embodiments, the sealing device 180 comprises a tongue that mates with a corresponding groove on the pivot 135.

The sealing device 180 is configured to provide a seal around the nose and mouth of a specimen to prevent gas from leaking into the environment, while helping ensure a known concentration of fluid (e.g., anesthesia gas) is being delivered to the specimen. The sealing device 180 may include an interior volume 182 to receive the mouth and nose of the specimen. As shown in FIG. 6C, the sealing device 180 may include an aperture 184 or opening to receive the mouth and nose of the specimen in the interior volume 182 of the sealing device 180. The entry to the sealing device 180 may comprise a flexible material 186 to fit snugly to the face of the specimen (e.g., a flexible material profiled to fit the face of a specimen). For example, the receiving end of the sealing device 180 (e.g., a portion of the front face) may comprise a flexible material that conforms to the specimen. In some embodiments, the front face of the sealing device 180 may comprise a shape memory material such as foam. The sealing device 180 seals and directs the fluid delivery to the nose and mouth of the specimen while creating minimal additional bulk.

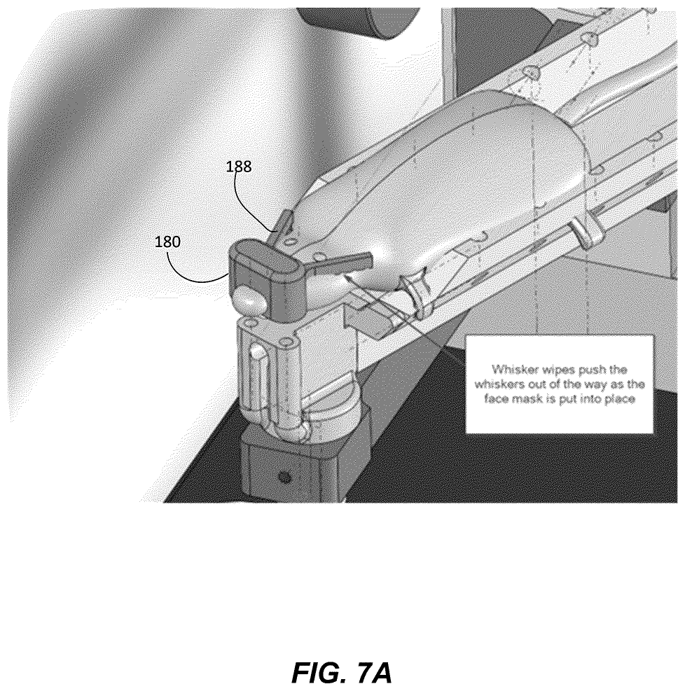

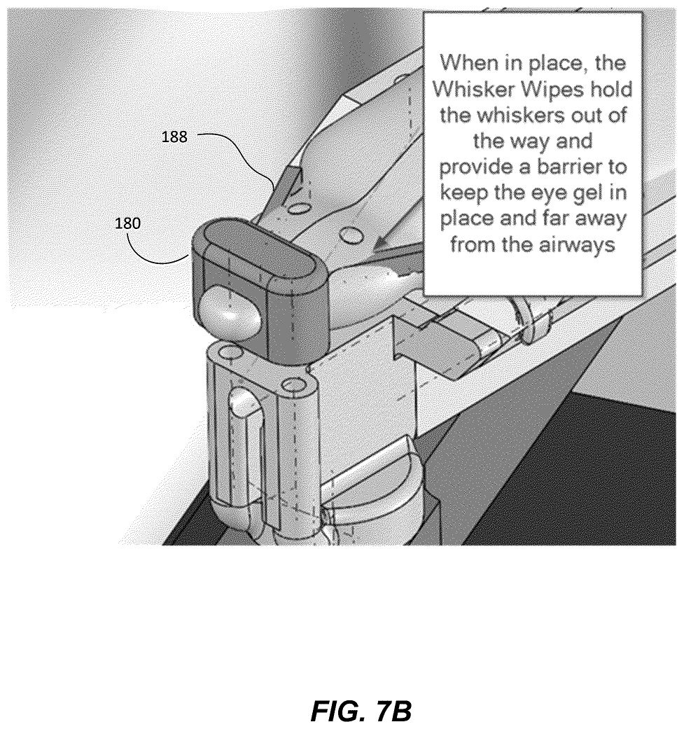

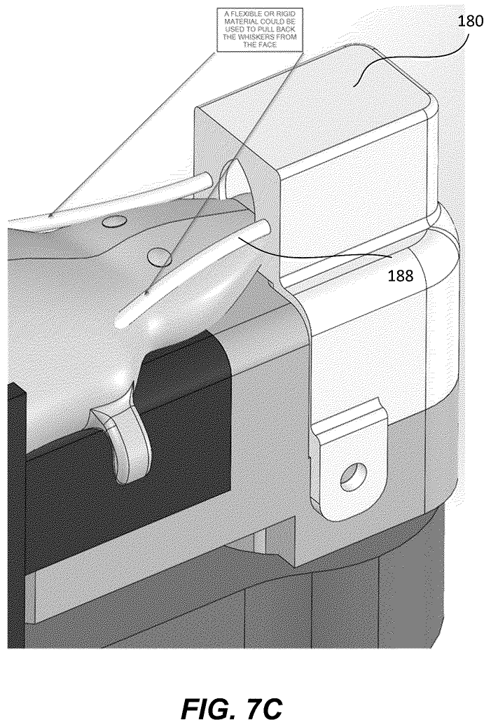

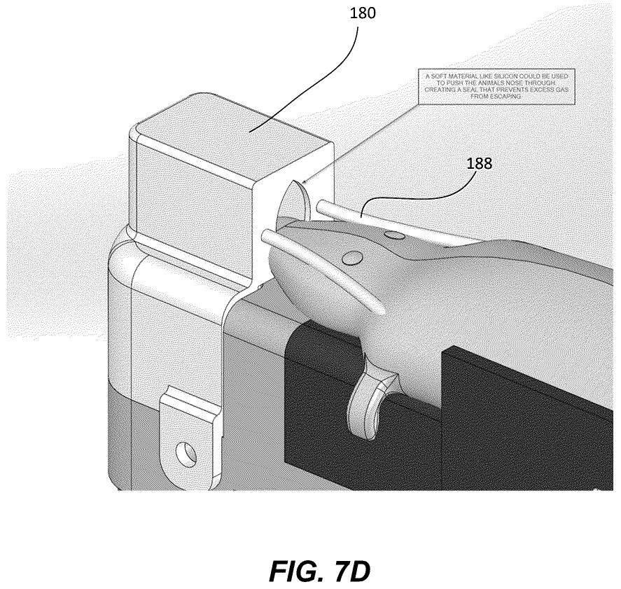

FIGS. 7A-7D show multiple views of the sealing device 180 disposed on a specimen. The sealing device 180 may include one or more shafts 188 extending from the front face of the sealing device 180. The shafts 188 extending from the front face of the sealing device 180 may be positioned adjacent to the receiving end of the sealing device 180 for receiving a portion of the face of a specimen. In some embodiments, the shafts 188 comprise a soft and flexible material (e.g., a polymer-based material or foam). The shafts 188 are configured to wipe along the face of the specimen as the sealing device 180 is attached to the pivot 135. In this way, any external appendages (e.g., whiskers or eyelashes) can be pushed and restrained away from the face of the specimen (e.g., the eyes of the specimen). The shafts 188 restrain external features of the specimen such that they do not block the imaging path of an imaging device. For example, when imaging the eyes of a specimen, the shafts 188 can pin whiskers down away from the eyes of the specimen. When imaging or inspecting the eyes of a specimen, especially when using analytic instruments that come in contact with the eye, the specimen's whiskers, eyelashes, and fur often get trapped between the instrument lens and the specimen and obstruct imaging. Some researchers use scissors to trim the offending fur, whiskers, and/or eye lashes to make imaging easier; however, this is deemed animal cruelty. The shafts 188 on the sealing device 180 can be made of soft, flexible material that wipes along the specimen's face as the sealing device 180 is being attached to the apparatus 100, to push the whiskers and fur away from the analytic instrument. The shafts 188 can be produced in various sizes and shapes to accommodate different specimens (e.g., for different ages, sizes, and species).

When imaging the eyes of a specimen using an analytic instrument that makes contact with the eye, viscous ophthalmic gel is often applied to the eye to create an optical coupling between the cornea and the lens of the instrument. The shafts 188 may also include features to help hold the eye gel in place when imaging (e.g., a lower retaining member). The eye gel will otherwise slide off the face of the subject while the subject is being moved into position. This holds the gel in place and prevents the gel from possibly falling into the airway and causing distress to the subject.

In some embodiments, the sealing device 180 optimizes anesthesia gas delivery by providing a tight seal around the subject's nose to prevent gas from leaking into the environment while ensuring a known concentration of anesthesia gas is being delivered to the subject. Conventional face coverings obstruct easy access to the animal, creating an inconvenient process and more of an obstruction. The sealing device 180 attaches to the apparatus 100 (e.g., the pivot or stand) and directs the gas delivery to the nose and mouth of the specimen while creating minimal additional bulk. The sealing device 180 can be disposable for infection control. The sealing device 180 can be produced in various sizes to adapt to animals of different ages and different species. In some embodiments, the sealing device 180 can be made from a pliable material, such as silicon, to fit snugly to the face of the animal. The animal can be positioned in front of the mask manually without the need of securing the sealing device 180 to the animal.

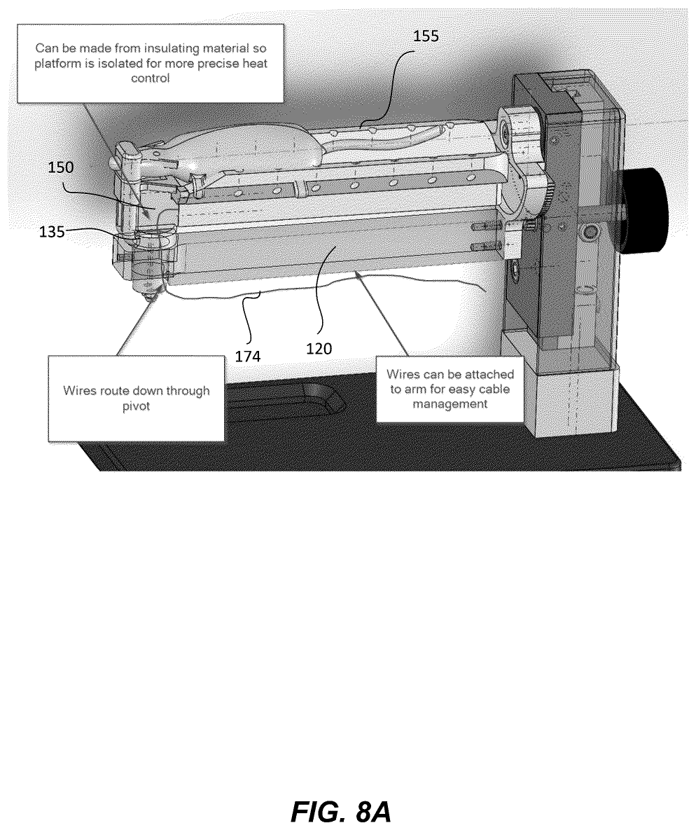

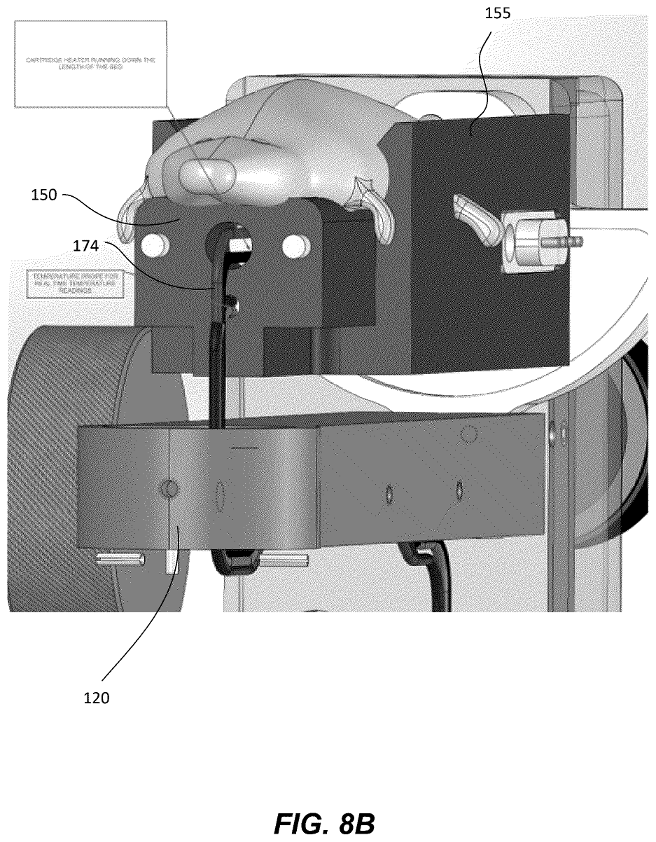

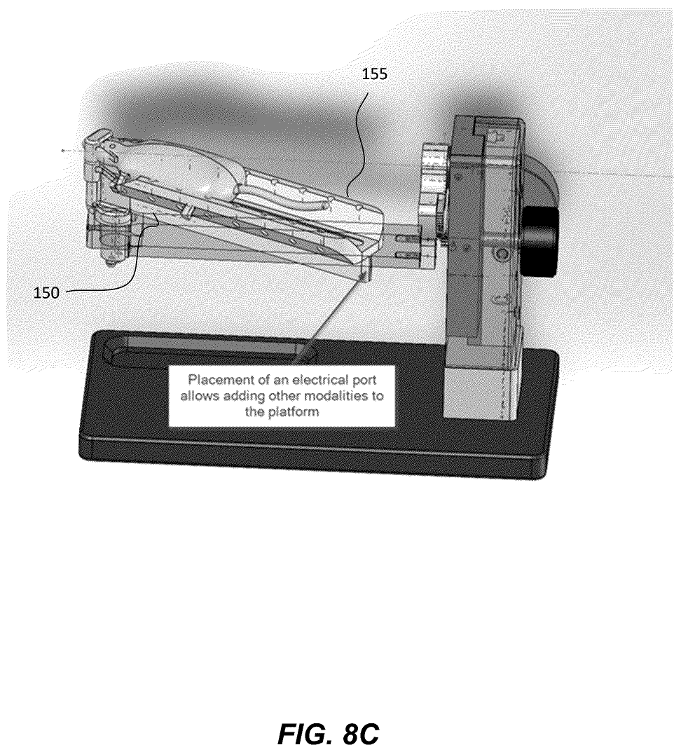

FIGS. 8A and 8B illustrate an apparatus including integrated wire routing for electronic components. The electrical wires 174 can be routed through the pivot 135. In some embodiments, the electrical wires 174 are removably attached to a surface of the mounting arm 120. In some embodiments, the electrical wires 174 are disposed within the mounting arm 120. In some embodiments, the electrical wires 174 are disposed in a cable management surface of the apparatus 100. The pivot 135 may include a slot for receiving the electrical wires 174 or other cables. The slot is configured to receive wiring or electrical cables therein. The slot prevents the wiring or electrical cables from crimping or damage and allows for efficient cable management. As shown in FIG. 8B, the stand 150 can receive electrical wires 174 routed through or along the mounting arm 120.

The platform 155 is disposed on a stand 150. The platform 155 may be removably attached to the stand 150. In some embodiments, the platform 155 comprises a different material than the stand 150. For example, the stand 150 may comprise an insulating material and the platform 155 may comprise a conductive material. In some embodiments, the stand 150 comprises fiberglass, wood, rubber, a mineral-based material, a polymer, polystyrene, polyisocyanurate, polyurethane, and/or a foam. In some embodiments, the platform 155 may comprise a conductive material such as a metal (e.g., aluminum). The platform 155 can allow for precise heat control of the stand 150. In some embodiments, the stand 150 and/or platform 155 can receive electrical wires 174 routed through or along the mounting arm 120. For example, the stand 150 may receive a heating cartridge to heat the stand and a temperature probe to provide real-time monitoring of temperature readings. FIG. 8C shows an electrical port on a region of the stand 150 or platform 155. The electrical port can provide additional modalities to the apparatus 100.

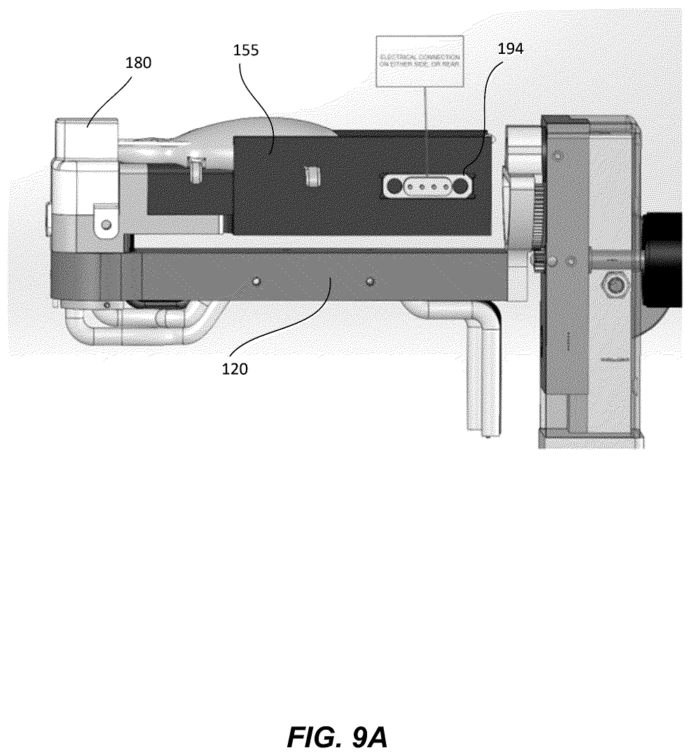

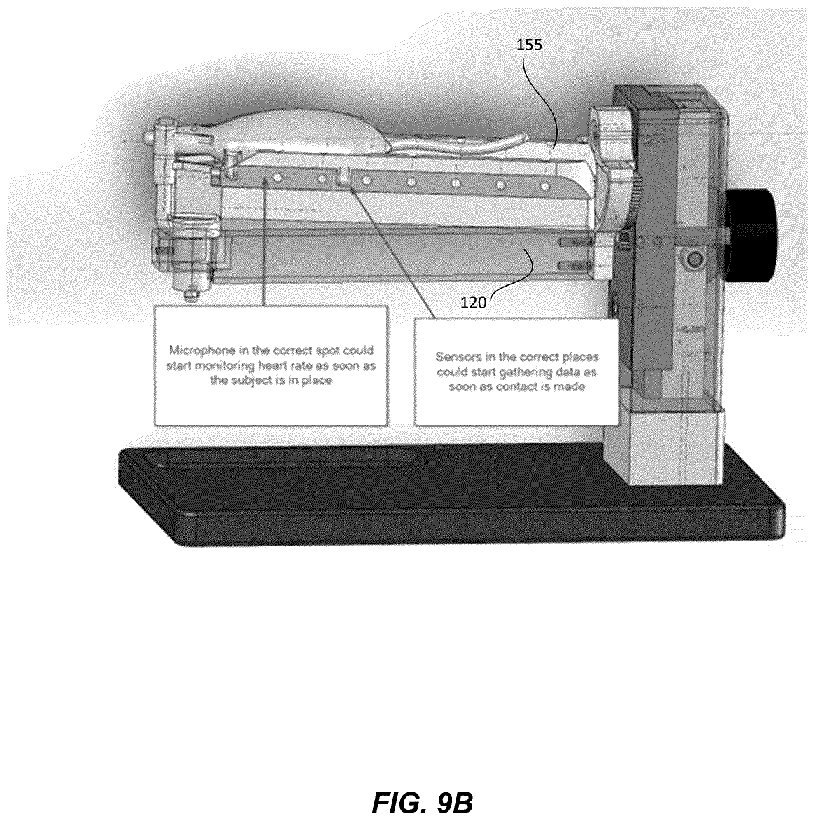

FIG. 9A illustrates integrated sensor ports on the apparatus for collecting sensor readings from the specimen. During an observation, surgical procedure, or experimental procedure that may include the use of anesthesia gas, sensors to measure vital statistics, heaters, and other probes may be required. Additionally, researchers are often interested in collecting sensor readings from the subject animal. This may include heart rate, respiration rate, blood pressure, blood oxygenation, and other similar readings. Sensors are readily available for these measurements, but they need to be connected to a data collection computer. In most cases, this connection is via sensor wires. The apparatus 100 may include electrical sensor ports for sensors (e.g., DC voltage sensors) to connect directly to the apparatus 100 to take advantage of the internal wire routing and cable management of the apparatus without limiting the range of motion of the stand. The wires can route along the electrical wiring for easy cable management without worrying about pulling the specimen off the stand or the wires interfering with the procedure being performed.

FIG. 9B illustrates an integrated heart rate monitor for collecting heart rate measurements from the specimen. In some embodiments, the sensors should communicate with software for automated data collection over time for a specimen. To collect heart rate data from a specimen, an integrated heart rate monitor with sensors that communicate with software for automated data collection over time can be used, leveraging technologies like ECG or photoplethysmography (PPG). In some embodiments, the sensors can be wearable devices such as chest straps (e.g., ECG straps) that pick up electrical signals originating from the heart or wristbands or smartwatches that integrate PPG sensors for continuous heart rate monitoring. The sensors can provide real-time heart rate data, and software can be used to automatically capture and store heart rate data over time, allowing for trend analysis and identification of patterns. The data can be stored locally or transmitted to a cloud environment for analysis and interpretation. For animal comfort and safety, and to prevent certain variations in measurement associated with decreased body temperature, the subject should be kept at normal body temperature during a sequence of observations.

In some embodiments, the apparatus 100 includes integrated electronic circuitry that leads to the stand. The stand may include one or more sensor ports that are in communication with the electronic circuitry. In some embodiments, a connector may be coupled to at least one of the sensor ports. The connector is configured to provide one or more connection ports to attach an external device. For example, the one or more sensor ports may include connect ports for a blood oxygen monitor, a heart rate monitor, a blood pressure monitor, a respiration rate monitor, a blood oxygen monitor, or combinations thereof. In some embodiments, the connector is a magnetic connector.

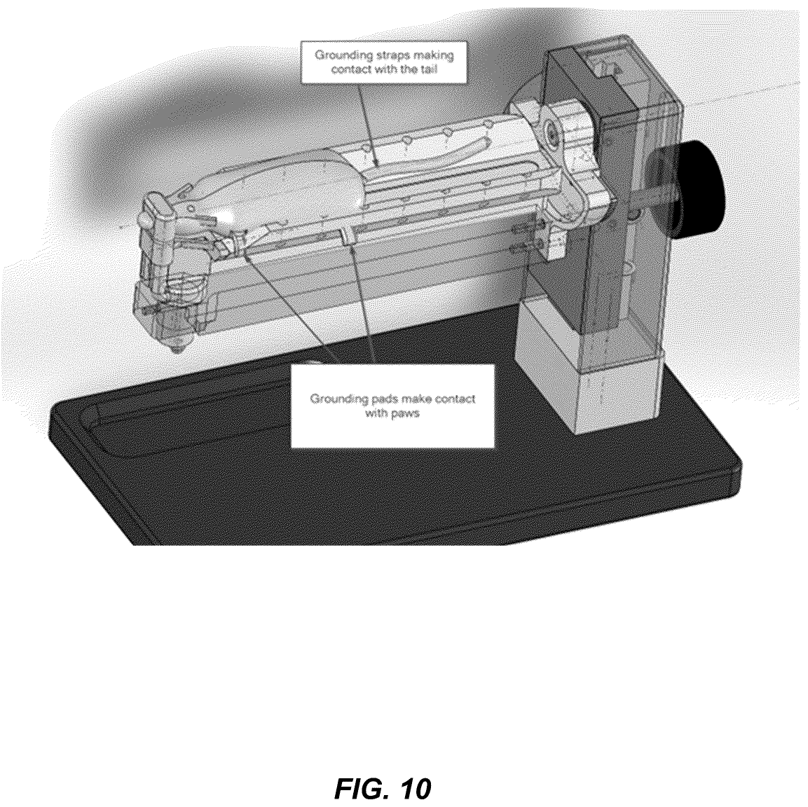

FIG. 10 illustrates an apparatus including grounding components. The grounding components provide a sink for charge. The grounding components can be used for high-gain sensors to filter signal or noise from readings. In some embodiments, the grounding components comprise grounding pads. The grounding pads can be disposed on a portion of the platform. For example, the grounding pads can be a surface that receives or retains an appendage of a specimen. In some embodiments, the grounding component comprises a strap or restraining mechanism that attaches to the specimen.

In some embodiments, the grounding components can include grounding wires. The grounding wires can be routed through the pivot for ease of cable management. For example, the grounding wires can be routed through the cable management system. In some embodiments, a specimen can be placed on the platform of the apparatus for eye imaging. The eye imaging procedure may include an electroretinography (ERG) test to measure the electrical response of the retina to light. The ERG test may be performed by placing an electrode on the cornea of the eye of a specimen. The electrodes are extremely high-gain to pick up electrical response signals, so all metal acts as an antenna that picks up electrical room noise. By grounding the specimen and the platform using the grounding components, the electrical noise can be filtered out, improving the signal to noise ratio. To aid in a good electrical connection to the specimen, gel or electrically conductive putty can be applied to the specimen for contact with the platform.

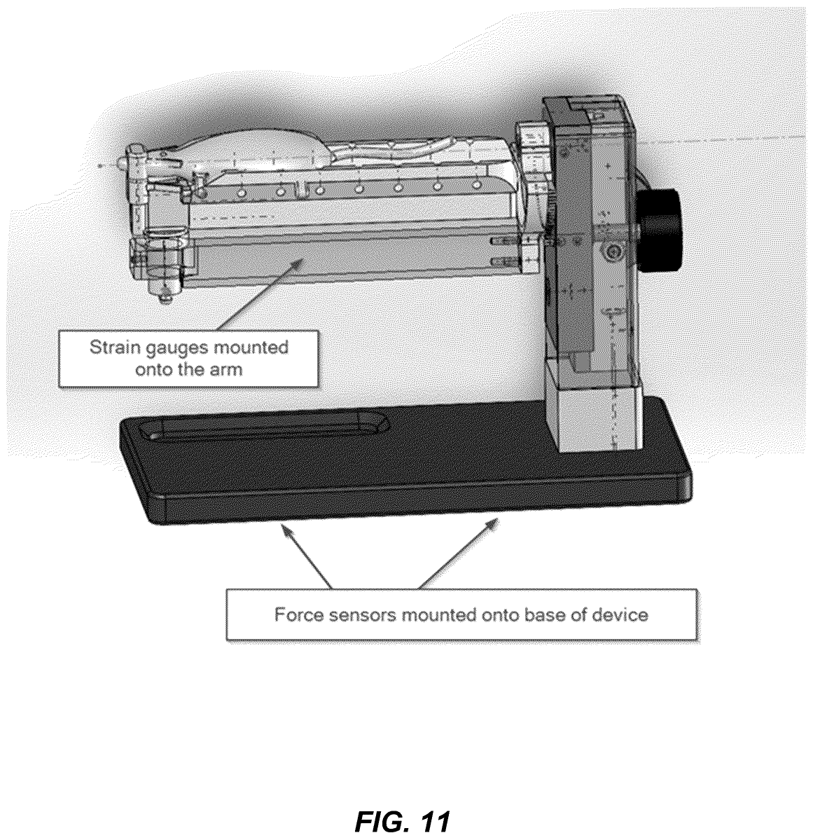

FIG. 11 illustrates an apparatus including an integrated scale for collecting weight data from the specimen. In some embodiments, the integrated scale provides weight measurement of a specimen on the platform of the apparatus. The integrated scale may comprise a sensor that communicates with software to provide automated weight measurements. The weight measurements can be collected when the specimen is placed on the platform of the apparatus and recorded with all other data to progressively monitor the specimen over time. In some embodiments, the integrated scale comprises force sensors on the base of the apparatus. In some embodiments, the integrated scale comprises strain gauges mounted onto the adjustable arm.

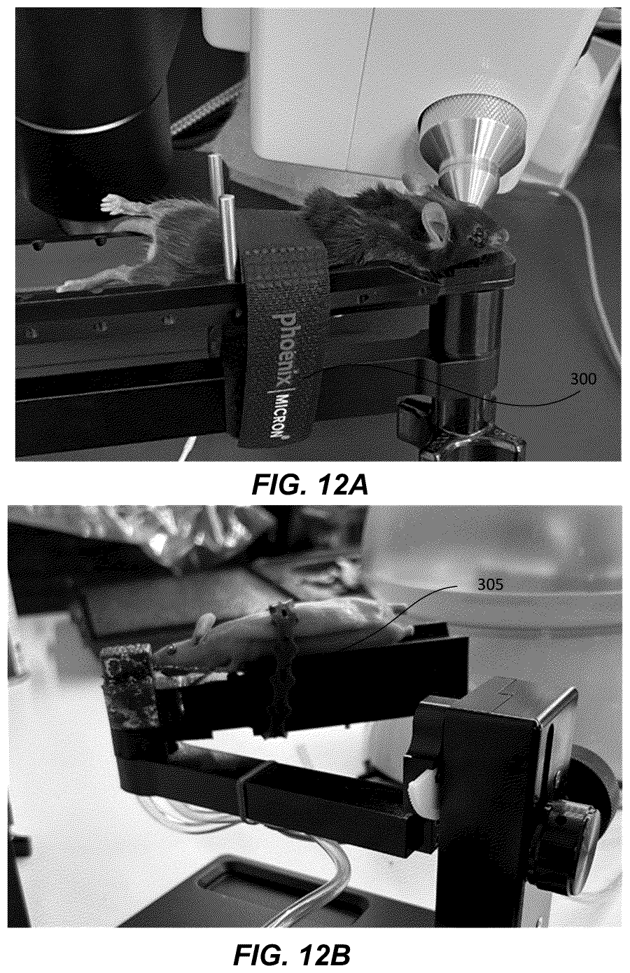

FIGS. 12A and 12B illustrate specimen restraining devices to restrain a specimen to a stand of the apparatus while the specimen is awake or sedated. The apparatus includes one or more restraints configured to retain a specimen on the stand. For example, the restraints may be configured to apply pressure between the specimen and the stand. In some embodiments, the restraints can be Velcro straps, a rubber strap, or a ratcheting mechanism. FIG. 12A shows Velcro straps 300 as an external element (e.g., not coupled to the apparatus) to restrain a mouse. In this way, the Velcro straps 300 can be applied to the desired region of the stand to restrain the specimen. The Velcro straps 300 may extend around the mounting arm and the stand to provide a desired tension to the specimen. FIG. 12B shows a rubber strap 305 may include a plurality of apertures and a pin. The pin can be inserted into one of the plurality of apertures to provide a snug fit of the specimen to the stand.

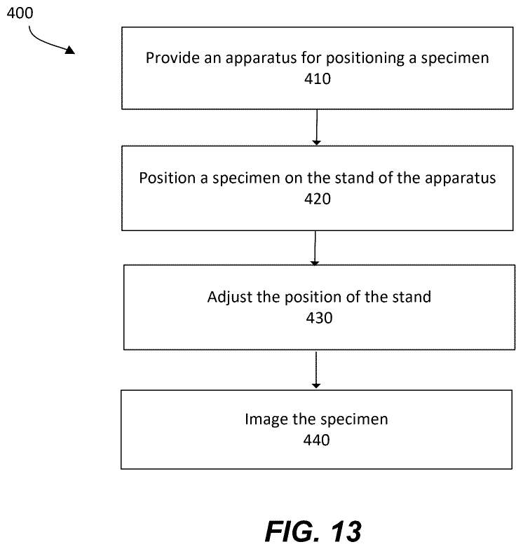

FIG. 13 provides a method of positioning and imaging a specimen according to some embodiments. The method 400 includes providing an apparatus for positioning a specimen for imaging 410. The apparatus may include any of the devices described herein. The apparatus may include a base member comprising a first end and a second end; an upright member disposed at or adjacent to the second end of the base member, wherein the upright member comprises a rotatable support; an adjustable arm extending from the upright member, wherein the adjustable arm comprises: a mounting arm coupled to the rotatable support on the upright member; a pivot attached to a distal end of the mounting arm, wherein the pivot comprises an inlet; and a stand attached to the pivot and disposed over the mounting arm; a first adjustment means disposed on the upright member and coupled to the adjustable arm via the rotatable support, wherein the first adjustment means is configured to adjust the yaw of the adjustable arm; and a second adjustment means coupled to upright member, wherein the second adjustment means is configured to move the upright member in a y-direction; wherein the stand can be rotated away or toward to the upright member via the pivot. The method 400 includes positioning a specimen on the stand 420. The method 400 includes adjusting the position of the specimen on the stand by exerting a force on one or more of the first adjustment means, the second adjustment means, or the pivot 430. The method 400 includes imaging the specimen 440. In some embodiments, the method 400 may include applying a sealing device over the mouth and nose of a specimen. In some embodiments, the method 400 includes administering a fluid to the sealing device via the apparatus. In some embodiments, the fluid is a gas. In some embodiments, the method 400 includes monitoring one or more vitals of the specimen using sensor ports including a blood oxygen monitor, a heart rate monitor, a blood pressure monitor, a respiration rate monitor, a blood oxygen monitor, or combinations thereof.

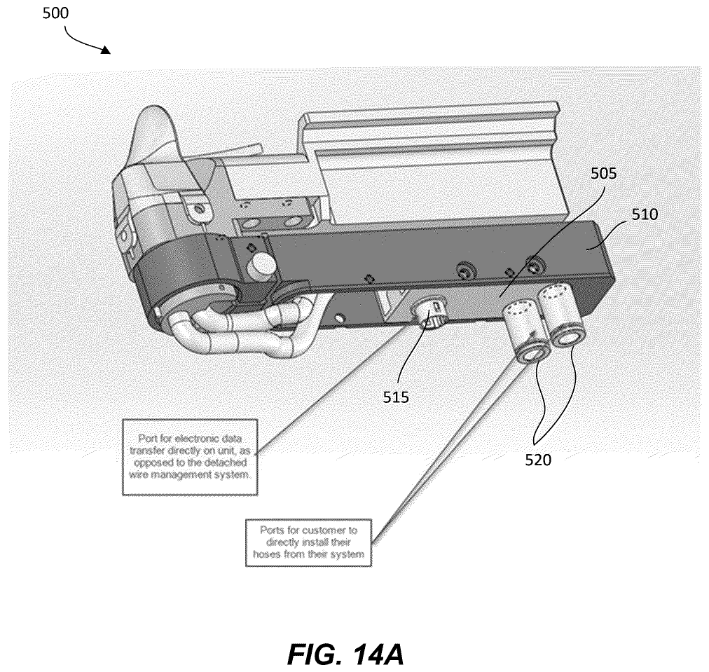

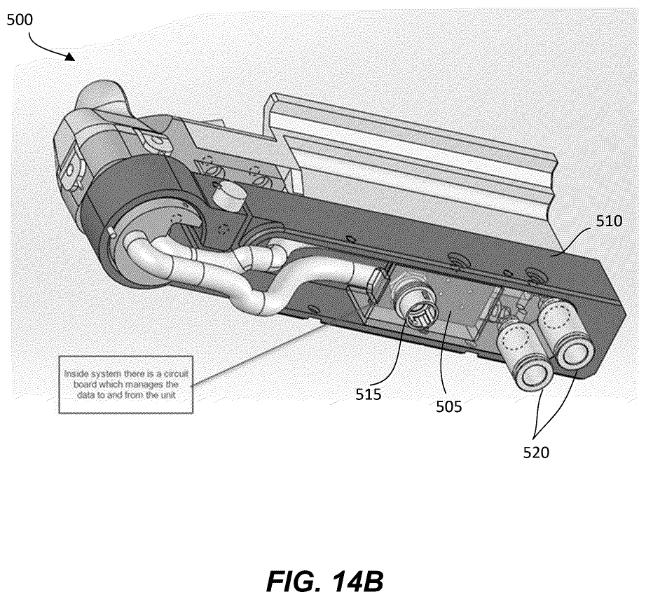

FIGS. 14A and 14B show an apparatus including an integrated circuit board according to some embodiments. The apparatus 500 may include a circuit board 505 disposed in the mounting arm 510. The circuit board 505 may be integrated into a portion of the apparatus 500. For example, the circuit board 505 can be housed within the mounting arm 510 or other regions of the apparatus 500. In some embodiments, the circuit board 505 may be disposed within the mounting arm 510. The circuit board 505 can include a port 515 for electrically connecting components to the apparatus 500. For example, the port 515 is configured to transfer electronic data directly from the apparatus 500. In some embodiments, the circuit board 505 can eliminate the need for a wire management system, as the circuit board can provide all electrical functionality. In this embodiment, the circuit board 505 is mounted directly inside mounting arm 510 to allow the wiring to be tucked away. The circuit board 505 may include one or more additional connectors. The connectors can be any electrical connection (e.g., audio connector, USB connector, power connector, docking connector, etc.). The mounting arm 510 can also include one or more hose ports 520. The hose ports 520 allow for easy connection of gas and scavenge air lines that can be routed through the mounting arm 510 to other regions of the apparatus 500.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An apparatus for positioning a specimen for imaging, the apparatus comprising:
a base member comprising a first end and a second end;
an upright member disposed at or adjacent to the second end of the base member, wherein the upright member comprises a rotatable support;
an adjustable arm extending from the upright member, wherein the adjustable arm comprises:
a mounting arm coupled to the rotatable support on the upright member;
a pivot attached to a distal end of the mounting arm; and
a stand attached to the pivot and disposed over the mounting arm;
a first adjustment means disposed on the upright member and coupled to the adjustable arm via the rotatable support, wherein the first adjustment means is configured to adjust the yaw of the adjustable arm; and
a second adjustment means coupled to upright member, wherein the second adjustment means is configured to move the upright member in a y-direction;
wherein the stand can be rotated away or toward to the upright member via the pivot.

2. The apparatus of claim 1, wherein the base member further comprises a receiving block for receiving the upright member therein, wherein the receiving block is fixed on the base member.

3. The apparatus of claim 2, wherein the upright member includes a movable platform housed within the receiving block, wherein the second adjustment means translates the upright member in the y-direction within the receiving block.

4. The apparatus of claim 1, wherein the rotatable support is integral with the mounting arm of the adjustable arm.

5. The apparatus of claim 1, wherein the rotatable support comprises a disc-shaped region comprising a first set of grooves.

6. The apparatus of claim 1, wherein the mounting arm comprises a second set of grooves that correspond to the first set of grooves on the rotatable support.

7. The apparatus of claim 1, further comprising:
one or more sensor ports disposed on the stand; and
electronic circuitry coupled to the sensor ports, wherein the electronic circuitry is disposed within the stand.

8. The apparatus of claim 7, further comprising a magnetic connector coupled to at least one of the sensor ports, wherein the magnetic connector is configured to provide one or more connection ports to attach an external device.

9. The apparatus of claim 7, wherein the one or more sensor ports comprise a blood oxygen monitor, a heart rate monitor, a blood pressure monitor, a respiration rate monitor, a blood oxygen monitor, or combinations thereof.

10. The apparatus of claim 1, further comprising a gas delivery system integrated into the pivot, wherein the gas delivery system comprises:
an inlet and an outlet disposed at a first end of the pivot, wherein the inlet is configured to receive a gas line;
a first channel disposed within the pivot extending from the inlet to a second end of the pivot; and
a second channel disposed within the pivot extending from the outlet to the second end of the pivot.

11. The apparatus of claim 10, further comprising a housing disposed below the adjustable arm, wherein the housing is configured to receive one or more fluid delivery lines.

12. The apparatus of claim 11, wherein the one or more fluid delivery lines can be coupled to gas containers to deliver gas to the gas delivery system integrated into the pivot.

13. The apparatus of claim 10, wherein the gas delivery system further comprises a sealing device removably attached to an end of the pivot.

14. The apparatus of claim 13, wherein the sealing device comprises a housing including an interior volume for receiving a portion of the specimen.

15. The apparatus of claim 14, wherein the housing comprises an aperture to receive the specimen within the interior volume, wherein a conformable material is disposed around the aperture to provide a seal around a nose and mouth of a specimen.

16. The apparatus of claim 15, wherein the conformable material is a plurality of flexible flaps.

17. The apparatus of claim 13, wherein the sealing device comprises at least two movable shafts disposed on an exterior of the sealing device, wherein the at least two movable shafts are configured to move outwardly from one another.

18. The apparatus of claim 17, wherein the at least two movable shafts comprise a flexible material.

19. The apparatus of claim 1, further comprising a heating platform disposed on the stand.

20. The apparatus of claim 1, further comprising a heating element integrated into the stand, wherein a heat sensor is disposed on the stand to measure temperature.

21. The apparatus of claim 1, wherein the stand comprises a base surface, a first sidewall, and a second sidewall, wherein the first sidewall and the second sidewall form an obtuse angle with respect to the base surface.

22. The apparatus of claim 21, wherein the base surface is thermally conductive.

23. The apparatus of claim 21, wherein the base surface comprises an absorbent pad.

24. The apparatus of claim 1, wherein the apparatus further comprises one or more restraints configured to retain a specimen on the stand.

25. The apparatus of claim 24, wherein the one or more restraints comprise Velcro straps, rubber straps, or a ratcheting mechanism.

26. A system for imaging a specimen, the system comprising:
an apparatus for positioning a specimen for imaging, the apparatus comprising:
a base member comprising a first end and a second end;
an upright member disposed at or adjacent to the second end of the base member, wherein the upright member comprises a rotatable support;
an adjustable arm extending from the upright member, wherein the adjustable arm comprises:
a mounting arm coupled to the rotatable support on the upright member;
a pivot attached to a distal end of the mounting arm, wherein the pivot comprises an inlet; and
a stand attached to the pivot and disposed over the mounting arm;
a first adjustment means disposed on the upright member and coupled to the adjustable arm via the rotatable support, wherein the first adjustment means is configured to adjust the yaw of the adjustable arm; and
a second adjustment means coupled to upright member, wherein the second adjustment means is configured to move the upright member in a y-direction;
wherein the stand can be rotated away or toward to the upright member via the pivot;
a gas delivery system comprising one or more fluid lines coupled to the inlet of the pivot; and
a sealing device removably attached to a distal end of the pivot; and
an imaging device.

27. The system of claim 26, wherein the sealing device comprises a housing including an interior volume for receiving a portion of the specimen.

28. The system of claim 27, wherein the housing comprises an aperture to receive the specimen within the interior volume, wherein a conformable material is disposed around the aperture to provide a seal around a nose and mouth of a specimen.

29. The system of claim 27, wherein the sealing device comprises at least two movable shafts disposed on an exterior of the sealing device, wherein the at least two movable shafts are configured to move outwardly from one another.

30. The system of claim 26, further comprising a heating platform disposed on the stand.

31. The system of claim 26, further comprising a heating element integrated into the stand, wherein a heat sensor is disposed on the stand to measure temperature.

32. The system of claim 26, wherein the apparatus further comprises:
one or more sensor ports disposed on the stand;
electronic circuitry coupled to the sensor ports, wherein the electronic circuitry is disposed within the stand; and
a magnetic connector coupled to at least one of the sensor ports, wherein the magnetic connector is configured to provide one or more connection ports to attach an external device.

33. A method of positioning and imaging a specimen, the method comprising:
providing an apparatus for positioning a specimen for imaging, the apparatus 2 comprising:
a base member comprising a first end and a second end;
an upright member disposed at or adjacent to the second end of the base member, wherein the upright member comprises a rotatable support;
an adjustable arm extending from the upright member, wherein the adjustable arm comprises:
a mounting arm coupled to the rotatable support on the upright member;
a pivot attached to a distal end of the mounting arm, wherein the pivot comprises an inlet; and
a stand attached to the pivot and disposed over the mounting arm;
a first adjustment means disposed on the upright member and coupled to the adjustable arm via the rotatable support, wherein the first adjustment means is configured to adjust the yaw of the adjustable arm; and
a second adjustment means coupled to the upright member, wherein the second adjustment means is configured to move the upright member in a y-direction;
wherein the stand can be rotated away or toward to the upright member via the pivot;
positioning a specimen on the stand;
adjusting the position of the specimen on the stand by exerting a force on one or more of the first adjustment means, the second adjustment means, or the pivot; and
imaging the specimen.

34. The method of claim 33, further comprising securing a sealing device on the pivot to retain the nose and mouth of a specimen in the sealing device.

35. The method of claim 34, further comprising supplying a gas to the sealing device via one or more fluid lines coupled to the inlet of the pivot.

36. The method of claim 35, further comprising pushing down the eyebrows or whiskers of a specimen using one or more flexible elongated shafts disposed on an exterior of the sealing device.

37. The method of claim 36, further comprising applying a heating source to the stand to maintain the body temperature of the specimen.

38. The method of claim 36, further comprising detecting one or more of blood oxygen, heart rate, blood pressure, or respiration rate, using one or more sensors disposed on the stand.
